(19) United States
(12) Patent Application Publication
(10) Pub. No.: US 2021/0148212 A1
(43) Pub. Date: May 20, 2021

(54) TREATMENT SYSTEMS AND METHODS USING ENCAPSULATED CORROSIVE FLUIDS

(71) Applicant: BOARD OF REGENTS, UNIVERSITY OF TEXAS SYSTEM, Austin, TX (US)

(72) Inventors: Mukul M. SHARMA, Austin, TX (US); Stoney Brett BARTON, Austin, TX (US)

(21) Appl. No.: 16/633,823

(22) PCT Filed: Jul. 27, 2018
(86) PCT No.: PCT/US2018/044115

§ 371 Date: Jan. 24, 2020

Related U.S. Application Data
(60) Provisional application No. 62/537,547, filed on Jul. 27, 2017.

(51) Int. Cl. E21B 43/27; C09K 8/70; C09K 8/80; C09K 8/52; C09K 8/68; C09K 8/54; C09K 8/60; E04H 4/12

(52) U.S. Cl. CPC E21B 43/27; C09K 8/706; C09K 8/80; C09K 8/52; C09K 8/685; E21B 37/06; C09K 8/605; E04H 4/1281; C09K 2208/10; C09K 2208/32; C09K 8/54

(57) ABSTRACT

Methods for treating bodies of water with encapsulated corrosive fluids are described. Corrosive fluids may include, for example, hydrochloric acid or other acids used in treating the bodies of water. The encapsulated corrosive fluids may also be used in for treatments in oil and/or gas wells.

### BACKGROUND OF THE INVENTION

### Field of the Invention

Embodiments described herein relate to systems and methods for treatment of water-based systems. More particularly, embodiments described herein relate to systems and methods for delivering corrosive fluids used to treat water-based systems. Some embodiments described herein relate to systems and methods for delivering corrosive fluids to consumers and for use in oil and/or gas wells.

### Description of the Relevant Art

Chemical treatment of bodies of water often includes the use of dangerous or difficult to handle chemicals. For example, swimming pools are often maintained using treatment with chlorine. Typical methods for delivering chlorine to swimming pools have to be carefully managed in order to avoid misuse of the chemicals and/or creation of dangerous situations. In addition, transport and handling of these chemicals often involves specialized equipment and regulated methods. Thus, there is a need for safer and easier methods for transport, handling, and delivery of chlorine and/or other water treatment chemicals to bodies of water such as swimming pools.

Acids (e.g., hydrochloric acid) are used in oil and/or gas wells to provide fluids used in, for example, fracturing of rock in subterranean formations. Acids are often currently delivered using polymers for encapsulating the chemicals. Encapsulation with polymers, however, may be expensive and/or difficult to control properly. Thus, there is a need for easier, more manageable, and lower cost methods for delivering acids and other chemicals into oil and/or gas wells and to manufacturing facilities for chemicals.

### BRIEF DESCRIPTION OF THE DRAWINGS

Features and advantages of the methods and apparatus of the embodiments described in this disclosure will be more fully appreciated by reference to the following detailed description of presently preferred but nonetheless illustrative embodiments in accordance with the embodiments described in this disclosure when taken in conjunction with the accompanying drawings in which:

FIG. 1 depicts a representation of an embodiment of a particle-encapsulated fluid.

FIG. 2 depicts a representation of an embodiment of a mixture of particle-encapsulated fluids.

FIG. 3 depicts examples of a mixture of particle-encapsulated fluids in a puck form or a ball form.

While embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION OF THE PREFERRED EMBODIMENTS

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

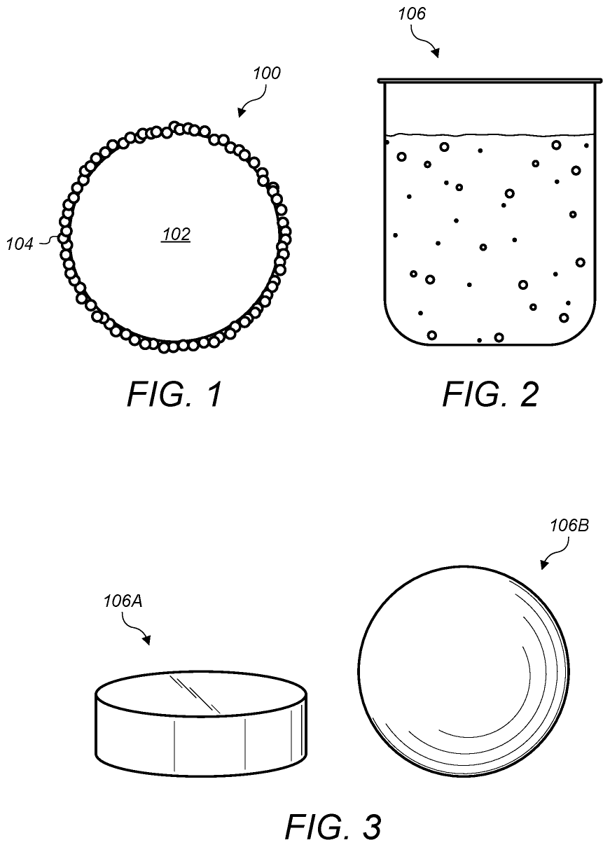

FIG. 1 depicts a representation of an embodiment of particle-encapsulated fluid 100. In certain embodiments, particle-encapsulated fluid 100 includes fluid 102 encapsulated in particles 104. Particle-encapsulated fluid 100 may be, for example, a “dry fluid” or powdered liquid (similar to “dry water” as described above). Particle-encapsulated fluid 100 may be formed using batch processing techniques described herein or any other suitable technique. Fluid 102 may be entrained or trapped in particles 104 such that the fluid is protected by the particles and inhibited from interaction with the external environment outside the particles. In some embodiments, fluid 102 may be released from particles 104 when particle-encapsulated fluid 100 is placed in certain environments (e.g., an environment that dissolves the particles or unbinds the particles from the surface of the fluid).

In certain embodiments, fluid 102 is a corrosive fluid. Fluid 102 may, for example, be a water-based corrosive fluid. In some embodiments, fluid 102 is a polar fluid. In some embodiments, fluid 102 is a biocide fluid. In some embodiments, fluid 102 is a chlorine-based fluid. In some embodiments the fluid may be a corrosive base, such as sodium or ammonium hydroxide. In certain embodiments, fluid 102 is chlorine-based acid. For example, fluid 102 may be hydrochloric acid or trichlorocyanuric acid. In some embodiments, fluid 102 is a bleaching agent such as sodium hypochlorite. It is to be understood that there may be overlap between the categories of corrosive fluids described above. For example, an acid may also be a biocide or an acid may be a bleaching agent. Additionally, in some embodiments, fluid 102 may include a combination of one or more of the above described fluids. Such combinations may, however, be limited by chemical compatibility between the fluids (e.g., the fluids in the combination may not have a dangerous or adverse reaction when mixed together).

In certain embodiments, particles 104 are nanoparticles. Particles 104 may be, for example, hydrophobic nanoparticles, silica nanoparticles, or fumed silica nanoparticles. In certain embodiments, particles 104 includes particles with particle sizes in a range between about 1 nm and about 100 μm. In some embodiments, particles 104 includes particles with particle sizes in a range between about 5 nm and about 100 nm. In some embodiments, particles 104 includes particles with particle sizes in a range between about 5 nm and about 50 nm.

In certain embodiments, particles 104 are hydrophobic particles (e.g., hydrophobic silica nanoparticles or hydrophobic fumed silica nanoparticles). Hydrophobic silica nanoparticles may be made by chemically treating silica nanoparticles with, for example, silanes or siloxanes to make the surfaces of the nanoparticles hydrophobic. In some embodiments, particles 104 include particles treated with an organosilane or other organic material to make the particles hydrophobic with an organic material coating. An example of an organosilane used for treatment includes HMDS (hexamethyldisilazane). The organic material coating may inhibit fluid 102 (e.g., the corrosive fluid) from attacking or degrading silica in particles 104. Examples of hydrophobic fumed silica nanoparticles that may be used as particles 104 include, but are not limited to, Evonik AEROSIL® R 812 (Evonik Industries AG, Essen, Germany), Evonik AEROSIL® R 812 S.

In some embodiments, particles 104 include particles that absorb fluid 102 instead of encapsulating the fluid. Such particles may be silica nanoparticles or precipitated silica nanoparticles that have a size range between about 5 nm and about 100 nm. An example of precipitated silica nanoparticles is Evonik SIPERNAT® 22.

In certain embodiments, a mixture of particle-encapsulated fluids 100 is made by combining fluid 102 and particles 104 in a high-speed blending process (e.g., a high-speed batch blending process). FIG. 2 depicts a representation of an embodiment of mixture 106 of particle-encapsulated fluids 100 (e.g., a mixture or plurality of encapsulated fluid particles). The high-speed blending process may include vigorous blending of a volume of fluid 102 and a plurality of particles 104 at high speeds to produce sheer forces that encapsulate the fluid with the particles to form mixture 106 of particle-encapsulated fluids 100. Other methods of making mixture 106 may also be contemplated. For example, a continuous encapsulation process may be used such as the liquid water encapsulation process disclosed in U.S. Pat. Appl. Pub. No. 2016/0038896 to Ezekoye et al., which is incorporated by reference as if fully set forth herein.

In some embodiments, fluid 102 is at least about 70%, at least about 85%, at least about 90%, or at least about 95% of mixture 106 (with the remaining percentage being particles 104) of particle-encapsulated fluids 100. For example, in one embodiment using hydrochloric acid as fluid 102 and hydrophobic particles, particles 104 (e.g., hydrophobic silica nanoparticles) have a mass of about 5 g per 50 ml of hydrochloric acid. As another example, in one embodiment using hydrochloric acid as fluid 102 and hydrophilic particles, particles 104 (e.g., hydrophilic silica nanoparticles) have a mass of about 20 g per 50 ml of hydrochloric acid. Thus, mixture 106 of particle-encapsulated fluids 100 may include a large volume of fluid 102 encapsulated by a relatively small amount of particles 104.

In some embodiments, mixture 106 may include more than one fluid encapsulated in particles 104. For example, two or more different fluids are combined in the process to form mixture 106 using encapsulated in particles 104. In such embodiments, however, the fluids encapsulated in the mixture are chemically compatible (e.g., do not have an adverse reaction). In some embodiments, mixture 106 may include two or more particle-encapsulated fluids 100. For example, mixture 106 may be a mixture of two different mixtures that are each formed separately from different fluids and/or different particles. In such embodiments, however, the fluids in the different mixtures may have to be chemically compatible when released from the particles (e.g., the fluids do not have an adverse reaction when combined).

In certain embodiments, mixture 106 of particle-encapsulated fluids 100, as shown in FIG. 2, includes a “dry fluid” or a powdered liquid mixture. For example, mixture 106 includes fluid 102 encapsulated in particles 104 in essentially a powder form. Particles 104 may entrain or trap fluid 102 (e.g., the corrosive fluid) in mixture 106. Entrapment of the corrosive fluid inside particles 104 in mixture 106 allows the mixture to be safely handled and/or transported as the particles inhibit external interaction with the corrosive fluid. For example, in certain embodiments, mixture 106 is a dryness that inhibits interaction of fluid 102 when particle-encapsulated fluids 100 in the mixture are contacted with a surface (e.g., particle-encapsulated fluids 100 do not wet or leach fluid into Kimwipes when contacted). Additionally, in certain embodiments, particle-encapsulated fluids 100 in mixture 106 do not have a tendency to absorb moisture from the air and become wet or saturated (e.g., have little to no hydroscopicity). Thus, mixture 106 may provide a safe “vessel” for handling and/or transport of the corrosive fluid. For example, mixture 106 may be placed and/or transported in plastic storage containers.

In certain embodiments, the vapor pressure of fluid 102 in mixture 106 is lower than a vapor pressure of the fluid itself. For example, if fluid 102 is hydrochloric acid, the vapor pressure in mixture 106 (e.g., the vapor pressure of fluid 102 in particle-encapsulated fluids 100) is less than the vapor pressure of hydrochloric acid, even at higher concentrations of hydrochloric acid. Thus, even though the vapor pressure of hydrochloric acid (or another corrosive fluid described herein) may be relatively high (and unsafe, especially at higher concentrations), encapsulating the hydrochloric acid in particles 104 in mixture 106 may reduce the vapor pressure of the hydrochloric acid to safer levels (e.g., levels suitable for handling and/or transport). Reducing the vapor pressure of the hydrochloric acid to safer levels and increasing the potential for transport of the hydrochloric acid may increase commercial uses of mixture 106 as the mixture with hydrochloric acid may be transportable through standard shipping methods that are otherwise unsuitable for transporting hydrochloric acid.

In some embodiments, mixture 106 may be formed into a selected shape for transport and/or handling. For example, particle-encapsulated fluids 100 in mixture 106 may be compressed into a desired shape. Examples of desired shapes include, but are not limited to, puck shapes or ball shapes. FIG. 3 depicts examples of mixture 106 in puck form 106A or ball form 106B. In certain embodiments, mixture 106 has long term stability. For example, particle-encapsulated fluids 100 may not degrade or leak any amount of fluid 102 over a period of months. In certain embodiments, mixture 106 is capable of being stored for longer periods of time in suitable storage environments. For example, mixture 106 may be stored in a minimal reactivity environment (e.g., a dark, cool temperature, low humidity storage container or facility) that allows the mixture to remain stable for even longer extended periods of times (e.g., years).

In certain embodiments, mixture 106 is used to treat a body of water. Mixture 106 may be provided to the body of water in, for example, a powdered form or a shaped form described herein. As described above, mixture 106 may be safe for a user (e.g., a consumer) to handle and provide to the body of water unlike handling a corrosive fluid in its liquid form, which may be dangerous and/or require specialized equipment. Examples of bodies of water that may be treated with mixture 106 include, but are not limited to, swimming pools, ponds, reservoirs, or other bodies of water that may be chemically treatable.

In certain embodiments, particle-encapsulated fluids 100 in mixture 106 may release fluid 102 from particles 104 when the mixture is provided to the body of water. For example, particles 104 may disperse or release from entrapping fluid 102 when particle-encapsulated fluids 100 in mixture 106 are added to the body of water. Mixture 106 may have a stability that is high enough to maintain particle-encapsulated fluids 100 when not in the presence of water (as described above) but a stability that is low enough to allow fluid 102 to be released when the mixture is contacted with water. In certain embodiments, no additional mechanical stimulation is needed to allow mixture 106 to release fluid 102 when the mixture is added to the body of water (e.g., no stirring or blending is needed). In such embodiments, mixture 106 may release fluid 102 over time as particle-encapsulated fluids 100 are gradually exposed to the body of water. For example, in a shaped form, particle-encapsulated fluids 100 towards the center of the shaped form of mixture 106 are released more slowly than particle-encapsulated fluids at the edges of the shaped form. The release rate of particle-encapsulated fluids 100 in mixture 106 may be controlled to provide a desired timed release of fluid 102 into the body of water (e.g., the fluid is released into the body of water in a time-controlled manner). For example, fluid 102 may be slowly released into the body of water in a time-controlled manner. In some embodiments, the release rate of particle-encapsulated fluids 100 in mixture 106 is controlled by the shape and/or size of the shaped form of the mixture. The release rate may also be controlled by the amount of compression (e.g., compressive force) used to form the shaped form of the mixture 106. In some embodiments, the release rate of particle-encapsulated fluids 100 in mixture 106 is controlled by adding a polymer (or other material) coating to particles 104 in the mixture.

In certain embodiments, mixture 106 is provided to the body of water to change the properties of the body of water. In such embodiments, fluid 102 released from mixture 106 is used to change the properties of the body of water. In some embodiments, mixture 106 is added to the body of water to control the pH of the body of water. For example, fluid 102 in mixture 106 may be hydrochloric acid or bleach encapsulated in particles 104 (e.g., silica nanoparticles). The hydrochloric acid or bleach may be released to control the pH of the body of water. In some embodiments, the hydrochloric acid or bleach is released into the body of water to chlorinate the body of water. Chlorination of the body of water may be used to control (e.g., reduce the presence of) bio-organisms and/or microorganisms in the body of water (e.g., fluid 102 in mixture 106 is used as a biocide or antimicrobial biocide in the body of water).

In some embodiments, one or more indicators are added to mixture 106. The indicators may be used to provide indication that mixture 106 has reacted with the body of water (e.g., fluid 102 has been released into the body of water) and/or provide indication that properties of the body of water have changed (e.g., the pH of the body of water has changed). Indicators may be added to mixture 106 by adding the indicators to fluid 102 and/or particles 104 used to make the mixture. In some embodiments, the indicators include color indicators such as dyes added to mixture 106. Color indicators may have a color that is seen in the body of water and/or a color that changes or disappears as mixture 106 interacts with the body of water. For example, mixture 106 may be dyed with a color that disappears as fluid 102 and particles 104 disassociate in the body of water (e.g., the shaped form of the mixture has the color and the color disappears as the disassociation takes place). As another example, mixture 106 may include an additive that changes color with changes in pH of the body of water. Thus, color indication of pH may be provided by the additive as mixture 106 interacts with the body of water. As yet another example, fluid 102 in mixture 106 may include a dye in addition to the corrosive fluid. As mixture 106 is formed, the dye may not be visible in the mixture as fluid 102 is encapsulated by non-dyed particles 104. The color may reappear in the body of water as fluid 102 (including the dye) is released into the body of water from mixture 106.

In some embodiments, one or more other additives are provided to mixture 106. Other additives may be compounds or fluids provided as a part of fluid 102 and/or as additions to particles 104 in mixture 106. In some embodiments, the other additives may be added to mixture 106 as value added compounds. For example, the other additives may be a separate mixture added to mixture 106. Examples of compounds (e.g., fluids) that may be used as other additives include, but are not limited to, hardness control compounds, calcium control compounds, scale control compounds, iron inhibitor compounds, and corrosion inhibitor compounds. For example, hardness control and/or calcium control compounds may be added hydrochloric acid as fluid 102 and used for treatment of swimming pool water (e.g., the body of water).

In some embodiments, the additives may include surfactants or other surface agents. Surfactants and/or surface agents may be used, for example, to reduce surface tension at the interface between the fluid (e.g., water) and particles 104 suspended in the fluid. Reducing the surface tension at the interface may increase mixing between the fluid and particles 104 and/or increase mixing of fluid 102 when released into the solution.

In some embodiments, mixture 106 is used in oil and/or gas well treatments. For example, mixture 106 may be used as diverter compounds and/or proppant compounds that are utilized in hydraulic fracturing operations. In some embodiments, mixture 106 is used in addition to diverter compounds and/or proppant compounds. Using mixture 106 in oil and/or gas well treatments may provide controlled release of fluid 102 (e.g., hydrochloric acid or another corrosive fluid). Controlled release of fluid 102 may include controlling the release rate over time of the fluid and/or delaying the release of fluid 102 until a time or event occurs in the oil and/or gas wells.

In some embodiments, fluid 102 are not released until fractures (or other openings) in the formation close or begin to close. In such embodiments, fluid 102 is released from mixture 106 when the fractures close and apply pressure to particle-encapsulated fluids 100 that releases the fluid from particles 104. Mixture 106 may be designed to release fluid 102 at certain pressures by, for example, selecting particles of certain sizes and/or adjusting processing properties during formation of the mixture. In some embodiments, mixture 106 is provided into wells ahead of a proppant (or diverter) and the mixture inhibits the proppant from entering microfractures or other small fractures until fluid 102 is released. Once fluid 102 is released (e.g., due to pressure increase in well/fractures), the fluid will flow throughout the well and proppant may enter areas previously blocked by mixture 106.

In certain embodiments, mixture 106 used in oil and/or gas wells includes acid (e.g., hydrochloric acid) as fluid 102 in the mixture. Such a mixture may be used for acidizing in the wells and/or for acid-fracturing of rocks in the oil-containing formation. In some embodiments, mixture 106 includes scale inhibitors, breakers (used in hydraulic fracturing), cross-linkers (used with fracturing fluids), corrosion inhibitors, and/or bactericides in fluid 102. Use of mixture 106 in oil and/or gas wells may provide a low-cost method for providing encapsulated fluids (e.g., acids) into the wells as well as allowing control over when (timing of release) and/or how (pressure of release) the fluids are released into the wells.

In some embodiments, mixture 106 is used in other water (or other fluid) treatment systems. For example, mixture 106 may be used in laundry systems (e.g., with laundry detergents) or other household systems (e.g., plumbing or drainage systems). In laundry systems, mixture 106 may be used, for example, to deliver a corrosive fluid such as bleach, acid, biocide, other oxygen-based fluid, laundry detergent, and/or other fluids in a time released manner. In some embodiments, a surfactant or surface agent, as described herein, may be added to mixture 106 for laundry system or household uses.

As another example, mixture 106 may be used in healthcare systems. In healthcare systems, mixture 106 may be used to control delivery of a healthcare-based solution. As yet another example, mixture 106 may be used for skin care products. For example, mixture 106 may be added to a skin care product to provide controlled delivery of the encapsulated fluid in the skin care product. The encapsulated fluid may be, for example, a skin-reactive solution, which may need a controlled release to prevent overreaction on the user's skin.

Further modifications and alternative embodiments of various aspects of the embodiments described in this disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described herein are to be taken as the presently preferred embodiments. Elements and materials may be substituted for those illustrated and described herein, parts and processes may be reversed, and certain features of the embodiments may be utilized independently, all as would be apparent to one skilled in the art after having the benefit of this description. Changes may be made in the elements described herein without departing from the spirit and scope of the following claims.

What is claimed is:

1. A method for treating a body of water, comprising:
providing a mixture of particle-encapsulated corrosive fluid into the body of water, wherein the mixture of particle-encapsulated corrosive fluid comprises corrosive fluid encapsulated in nanoparticles; and
allowing the mixture to release the corrosive fluid into the body of water.

2. The method of claim 1, wherein the corrosive fluid comprises hydrochloric acid.

3. The method of claim 1, wherein the nanoparticles are silica nanoparticles.

4. The method of claim 1, wherein the nanoparticles are hydrophobic nanoparticles.

5. The method of claim 1, wherein the nanoparticles are hydrophilic nanoparticles.

6. The method of claim 1, further comprising allowing the corrosive fluid to be released into the body of water in a time-controlled manner.

7. The method of claim 1, further comprising providing one or more encapsulated additives into the body of water.

8. The method of claim 1, further comprising providing mechanical stimulation to the body of water to release the corrosive fluid from the nanoparticles.

9. The method of claim 1, wherein the mixture of particle-encapsulated corrosive fluid is provided into the body of water in a shaped form.

10. The method of claim 1, wherein the mixture of particle-encapsulated corrosive fluid is provided into the body of water in a powdered form.

11. The method of claim 1, wherein the mixture of particle-encapsulated corrosive fluid comprises an indicator, wherein the indicator provides indication that the corrosive fluid is released into the body of water.

12. The method of claim 11, wherein the indicator comprises a color indicator.

13. The method of claim 1, wherein the body of water comprises a swimming pool.

14. A method for treating a subsurface well, comprising:
providing a mixture of particle-encapsulated corrosive fluid into one or more fractures extending from a well in a subsurface formation, wherein the mixture of particle-encapsulated corrosive fluid comprises corrosive fluid encapsulated in nanoparticles; and
allowing the mixture to release the corrosive fluid into the well when one or more of the fractures begin to close.

15. The method of claim 14, wherein the corrosive fluid is released into the well when a certain pressure is reached after the fractures begin to close.

16. The method of claim 14, wherein the mixture of particle-encapsulated corrosive fluid is provided into the fractures along with a diverter compound and/or a proppant compound.

17. The method of claim 14, wherein the mixture of particle-encapsulated corrosive fluid is provided into the fractures before a diverter compound and/or a proppant compound is provided into the well.

18. The method of claim 14, wherein the mixture of particle-encapsulated corrosive fluid includes scale inhibitors, breakers, cross-linkers, corrosion inhibitors, and/or bactericides.

19. The method of claim 14, wherein the well is an oil well.

20. The method of claim 14, wherein the well is a gas well.

21. The method of claim 14, wherein the corrosive fluid comprises hydrochloric acid.

22. The method of claim 14, wherein the nanoparticles are silica nanoparticles.

23. The method of claim 14, wherein the nanoparticles are hydrophobic nanoparticles.

24. The method of claim 14, wherein the nanoparticles are hydrophilic nanoparticles.
